(19) United States
(12) Patent Application Publication
(10) Pub. No.: US 2019/0348885 A1
(43) Pub. Date: Nov. 14, 2019

(54) MOTOR FOR VEHICLE AND ELECTRIC POWER STEERING DEVICE

(71) Applicant: Nidec Corporation, Kyoto (JP)

(72) Inventors: Takashi HATTORI, Kyoto (JP); Toshiya OKAMOTO, Kyoto (JP); Hiroshi OGAWA, Kyoto (JP); Yoshinobu ARAO, Kyoto (JP); Yoshiaki YAMASHITA, Kyoto (JP)

(21) Appl. No.: 16/347,866

(22) PCT Filed: Nov. 22, 2017
(86) PCT No.: PCT/JP2017/042082

§ 371 Date: May 7, 2019

Related U.S. Application Data
(60) Provisional application No. 62/425,668, filed on Nov. 23, 2016.

(30) Foreign Application Priority Data
Mar. 14, 2017 (JP) 2017-048645

(51) Int. Cl. H02K 3/52; H02K 3/38; B62D 5/04

(52) U.S. Cl. CPC H02K 3/522; H02K 3/38; B62D 5/0409; H02K 2203/09; B62D 5/0403

(57) ABSTRACT

A motor mounted on a vehicle includes a motor with a shaft placed along the central axis, a rotor radially opposed to the rotor through a gap, and a circuit board placed on one side of the axis of the stator and electrically connected to the stator. The stator includes a stator core, and a plurality of coils each including a winding portion which is defined by winding a coil wire onto the stator core. At least one of the plurality of coils is a first coil including a first extension which is defined by a portion of the coil wire extending to one side of the central axis from the winding portion. The first extension includes a connected portion connected to the winding portion, and a fixed portion fixed to the circuit board.

### CROSS REFERENCE TO RELATED APPLICATIONS

This is the U.S. national stage of PCT Application No. PCT/JP2017/042082, filed on Nov. 22, 2017, and priority under 35 U.S.C. § 119(a) and 35 U.S.C. § 365(b) is claimed from Japanese Application No. 2017-048645, filed Mar. 14, 2017 and United States Patent Application No. 62/425,668, filed Nov. 23, 2016; the disclosures of which are incorporated herein by reference.

### 1. FIELD OF THE INVENTION

The present disclosure relates to a motor for vehicle and an electric power steering device.

### 2. BACKGROUND

A known motor is equipped with a bus bar connected to a coil.

The bus bar described above is produced at a relatively high cost, which can easily lead to higher costs of producing motors. Moreover, when connecting a coil and controller, there is a need to connect a coil wire forming the coil and the bus bar and connect the bus bar and a circuit board for the controller. For this reason, it requires a lot more work to connect the coil and the controller, and therefore it takes more effort and cost to produce a motor.

In this regard, for example, connecting the coil wire directly to the circuit board can be considered. In this case, there is no need to provide the bus bar, so the coil and the controller can be connected by doing the connection work only once. This can prevent an increase in the effort and cost required to produce a motor.

Incidentally, motors for vehicle are used even in relatively low-temperature environments, particularly because temperature differences in the environment for motor use are likely to be big. As such, when the coil wire is connected directly to the circuit board as described above, relatively large thermal stress can occur to the connection between the coil wire and the circuit board due to thermal contraction and expansion of the coil wire. This may lead to defects such as cracks on the connection between the coil wire and the circuit board.

### SUMMARY

An example embodiment of the present disclosure provides a motor of vehicle which is mounted on a vehicle. The motor includes a motor with a shaft placed along the central axis, a rotor radially opposed to the rotor through a gap, and a circuit board placed on one side of the axis of the stator and electrically connected to the stator. The stator includes a stator core and a plurality of coils each including a winding portion which is defined by winding a coil wire onto the stator core. At least one of the plurality of coils is a first coil including a first extension defined by a portion of the coil wire extending to one side of the central axis from the winding portion. The first extension including a connected portion connected to the winding portion, and a fixed portion fixed to the circuit board. A total length of the first extension, from the connected portion to the fixed portion, is larger than a total length of a virtual line segment joining the connected portion and the fixed portion.

An example embodiment of the present disclosure provides an electric power steering device equipped with the above motor for vehicle.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view showing a motor of a vehicle according to an example embodiment of the present disclosure.

FIG. 2 is a perspective view showing a stator, first support member, and second support member according to an example embodiment of the present disclosure.

FIG. 3 is a perspective view showing some coils and the first support member according an example embodiment of the present disclosure.

FIG. 4 is a view showing a first coil according to an example embodiment of the present disclosure.

FIG. 5 is a view showing a second coil according to an example embodiment of the present disclosure.

FIG. 6 is a perspective view showing the first support member according to an example embodiment of the present disclosure.

FIG. 7 is a perspective view showing the second support member according to an example embodiment of the present disclosure.

FIG. 8 is a schematic diagram showing an electric power steering according to an example embodiment of the present disclosure.

### DETAILED DESCRIPTION

The Z axis properly shown in in each drawing is a vertical direction in which the plus side is an “upper side” and the minus side is a “lower side”. The central axis J properly shown in each drawing is a virtual line that is parallel to the Z axis and extends vertically. In the following description, a direction parallel to the axial direction, i.e., vertical direction, of the central axis J is simply referred to as “axial direction”, a radial direction with respect to the central axis J is simply referred to as “radial direction”, and a circumferential direction with respect to the central axis J is simply referred to as “circumferential direction”. In this example embodiment, the upper side corresponds to one side of the axis, and the lower side corresponds to the other side of the axis.

In addition, the vertical direction, the upper side, and the lower side are simply names for explaining the relative positional relationship among the respective portions, and the actual positional relationship or the like may be a positional relationship or the like other than the ones indicated by these names.

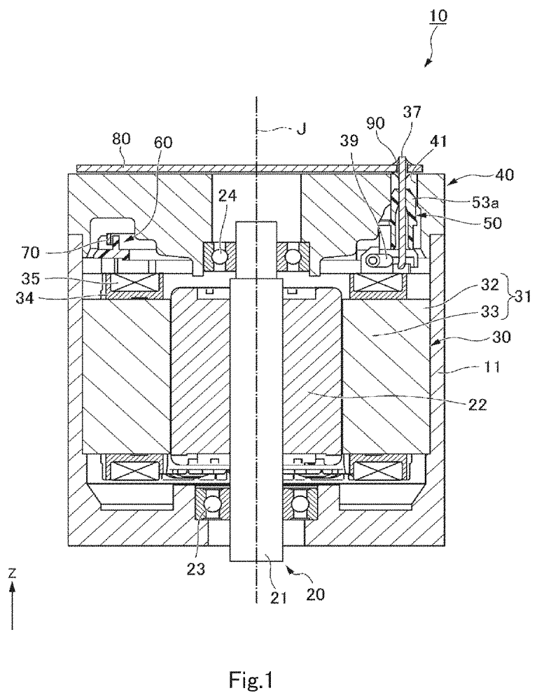

A motor for vehicle 10 of this example embodiment shown in FIG. 1 is a motor mounted on a vehicle. As shown in FIG. 1, the motor for vehicle 10 comprises a housing 11, a bearing holder 40, bearings 23 and 24, a rotor 20, a stator 30, a first support member 50, a second support member 60, a neutral bus bar 70, and a circuit board 80.

The housing 11 is in the shape of a cylinder that has a bottom portion and opens upward. The bearing 23 is held at the bottom portion of the housing 11. The bearing holder 40 is secured to an opening on the upper side of the housing 11. The bearing holder 40 holds the bearing 24. The bearing holder 40 has a holder through-hole 41 that penetrates the bearing holder 40 in an axial direction. In an inside space surrounded by the housing 11 and the bearing holder 40, the rotor 20, stator 30, first support member 50, second support member 60, and neutral bus bar 70 are contained.

The rotor 20 has a shaft 21 and a rotor body 22. The shaft 21 is placed along the central axis J. The shaft 21 is cylindrical around the central axis J. The shaft 21 is supported by the bearings 23 and 24 so as to be rotatable around the central axis J. The lower end of the shaft 21 protrudes out from the housing 11 through a hole formed in the bottom portion of the housing 11. Although not shown, the rotor body 22 has a rotor core secured to the outer circumference of the shaft 21 and a rotor magnet secured to the outer circumference of the rotor core.

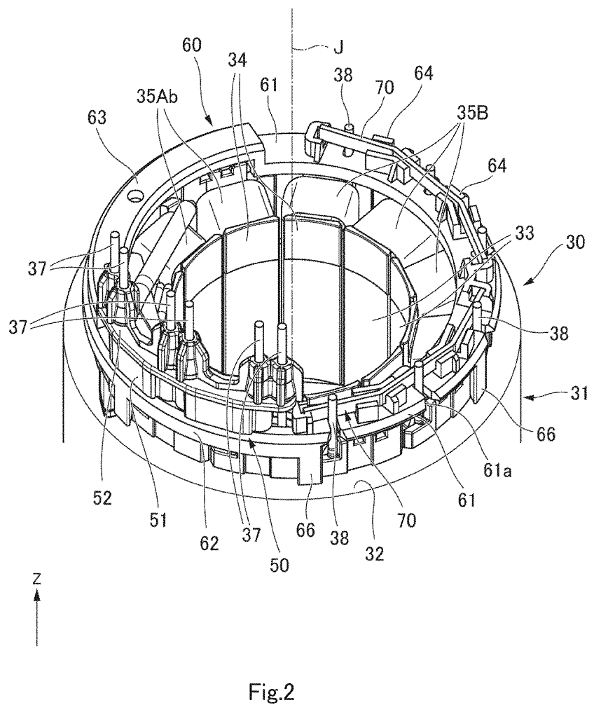

The stator 30 is radially opposed to the rotor 20 through a gap. As shown in FIG. 2, the second support member 60 is placed above the stator 30, and supports the neutral bus bar 70 from the underside. The first support member 50 is placed above the second support member 60. As shown in FIG. 1, the first support member 50 is inserted into the holder through-hole 41.

As shown in FIG. 2, the neutral bus bar 70 is an angulated bending plate member that extends along the circumference. The plate surface of the neutral bus bar 70 is perpendicular to the radius. In this example embodiment, two neutral bus bars 70 are installed along the circumference. The neutral bus bars 70 connect two or more of a plurality of coils 35 to be described later as neutral points.

As shown in FIG. 1, the circuit board 80 is in the shape of a plate that widens out radially. The circuit board 80 is placed above the stator 30. In this example embodiment, the circuit board 80 is placed above the bearing holder 40. The circuit board 80 is part of the controller of the motor for vehicle 10. Although not shown, the controller is secured to the top side of the bearing holder 40.

The stator 30 has a stator core 31, an insulator 34, a plurality of coils 35, and an insulation tube 39. The stator core 31 is in the shape of a ring around the rotor body 22, radially outside the rotor body 22. The stator core 31 has a core back 32 and a plurality of teeth 33. As shown in FIG. 2, the core back 32 is in the shape of a circular ring around the central axis J. The teeth 33 protrude radially inward from the core back 32. The plurality of teeth 33 are arranged at equal intervals around the entire circumference. The number of teeth 33 is 12, for example.

The insulator 34 is a member with insulation properties. The insulator 34 is mounted on each of the teeth 33. The plurality of coils 35 are mounted on each of the plurality of teeth 33 through the insulator 34. In this example embodiment, the plurality of coils 35 comprise first coils 35A and second coils 35B. Further, the first coils 35A comprise third coils 35Aa and fourth coils 35Ab.

In this example embodiment, a total of twelve coils 35 are installed, including three third coils 35Aa, three four coils 35Ab, and six second coils 35B. In this example embodiment, the coils 35 are interconnected in a star connection. In the description below, the first coils 35A and the second coils 35B are simply referred to as coils 35 unless particularly distinguished from each other. Also, the third coils 35Aa and the fourth coils 35Ab are simply referred to as the first coils 35A unless they are distinguished from each other.

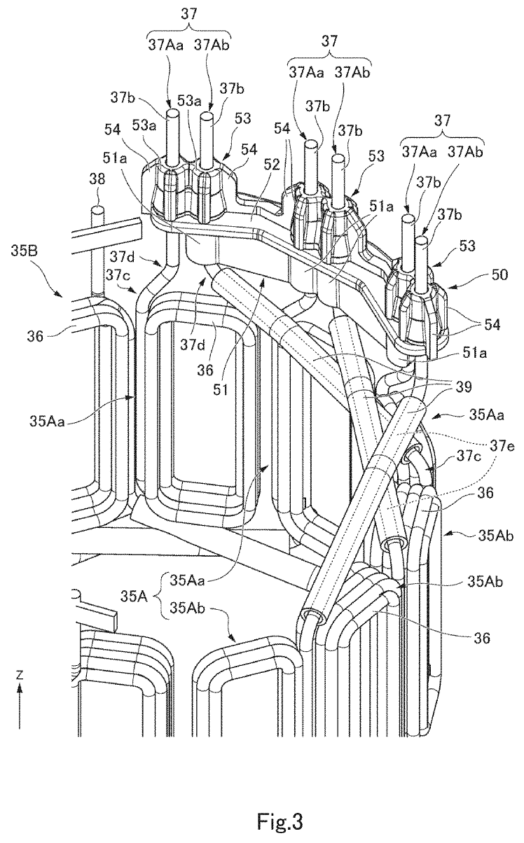

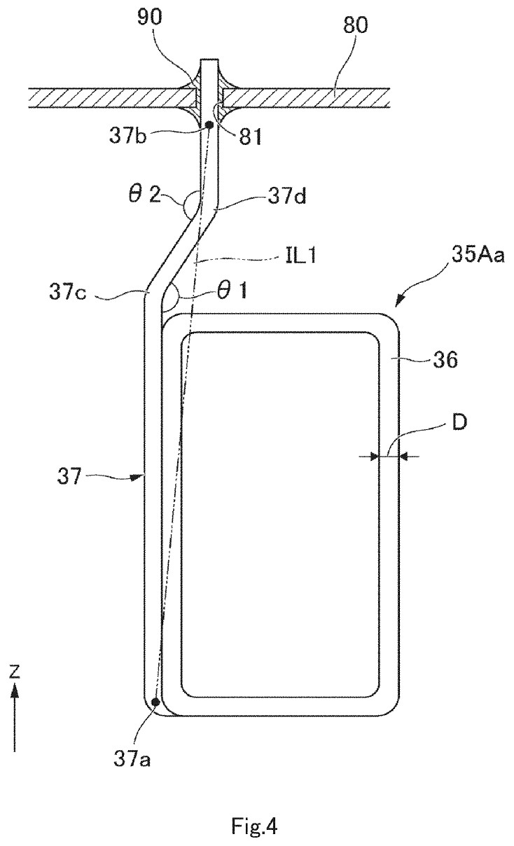

As shown in FIGS. 3 and 4, the plurality of coils 35 each have a winding portion 36. The winding portion 36 is formed by winding a coil wire onto the stator core 31. In this example embodiment, the winding portion 36 is formed by winding a coil wire onto the teeth 33 through the insulator 34. The winding portions 36 of the coils 35 are arranged at equal intervals around the entire circumference. The winding portions 36 are in the shape of a rectangular frame with rounded corners. In this example embodiment, the coil wires forming the winding portions 36 are round wires. The coil wires forming the winding portions 36 have a wire diameter D not less than 0.5 mm and not more than 5 mm, for example. Incidentally, in FIG. 3, the parts of the winding portions 36 that are within the radius are not shown.

As shown in FIG. 4, the first coil 35A has a first extension 37. At least one of the plurality of coils 35 is a first coil 35A having a first extension 37. The first extension 37 is formed by extending the coil wire upward from the winding portion 36. The first extension 37 extends upward from the winding portion 36, and is connected to the circuit board 80. The coil wire forming the winding portion 36 and the coil wire forming the first extension 37 are part of a single continuous coil wire. The first extension 37 has a connected portion 37a and a fixed portion 37b.

The connected portion 37a is an end portion on the lower side of the first extension 37, and is a portion connected to the winding portion 36. In this example embodiment, the connected portion 37a is connected to a winding end terminal of the coil wire forming the winding portion 36. That is, in this example embodiment, the first extension 37 extends upward from the winding end terminal of the coil wire forming the winding portion 36. In this example embodiment, the winding end terminal of the coil wire forming the winding portion 36 is an end portion on the lower side of the winding portion 36.

The fixed portion 37b is a portion fixed to the circuit board 80. The fixed portion 37b is placed above the winding portion 36. In this example embodiment, the fixed portion 37b is passed through a through-hole 81 that penetrates the circuit board 80 in an axial direction, and protrudes above the top surface of the circuit board 80. The fixed portion 37b is fixed to the circuit board 80 with solder 90. More specifically, the solder 90 fixes the fixed portion 37b to the top and bottom surfaces of the circuit board 80. As the fixed portion 37b is fixed to the circuit board 80, the circuit board 80 is electrically connected to the stator 30.

The length of the first extension 37, from the connected portion 37a to the fixed portion 37b, is larger than the length of a virtual line segment IL1 joining the connected portion 37a and the fixed portion 37b. Thus, since the length of the first extension 37, from the connected portion 37a to the fixed portion 37b, is larger than the shortest length required to join the connected portion 37a and the fixed portion 37b, the first extension 37 is long enough. As such, even if the first extension becomes shorter due to thermal contraction, the sufficient length of the first extension 37 allows for absorbing the deformation of the first extension 37. This can reduce the thermal stress applied to the fixed portion 37b, thereby preventing cracks in the solder 90 or other defects, such as unfixing of the fixed portion 37b from the circuit board 80. Thus, according to this example embodiment, it is possible to provide a motor for vehicle 10 capable of reducing defects on a connection between coil wires and the circuit board 80.

In addition, it is desirable that the relationship between the aforementioned length of the first extension 37, from the connected portion 37a to the fixed portion 37b, and the length of the virtual line segment IL1 be satisfied at least in a room-temperature environment. That is, for example, at a temperature lower than room temperature, the length of the first extension 37, from the connected portion 37a to the fixed portion 37b, and the length of the virtual line segment IL1 may become equal by thermal contraction of the first extension 37. The room temperature includes a temperature range of, for example, 5° C. to 35° C. as defined in JIS Z 8703:1983.

Moreover, the point at the fixed portion 37b connected by the virtual line segment IL1 is the point on the fixed portion 37b closest to the connected portion 37a—that is, the point on the lower side in this example embodiment. In this example embodiment, the point on the fixed portion 37b connected by the virtual line segment IL1 is located below the bottom surface of the circuit board 80.

In a case where the fixed portion 37b is fixed to the circuit board 80 by the solder 90, as in this example embodiment, the fixing strength of the fixed portion 37b is likely to be lower compared to when the fixed portion 37b is fixed to the circuit board 80 by welding, caulking, etc. The effect of reducing the thermal stress applied to the fixed portion 37b is useful especially when the fixed portion 37b is fixed to the circuit board 80 with the solder 90.

Moreover, for example, when fixing the fixed portion 37b to the circuit board 80 by welding, it is necessary to separately install metallic parts, etc. protruding from the circuit board 80 and to fix the fixed portion 37b by the metallic parts, etc. Additionally, for example, when fixing the fixed portion 37b to the circuit board 80 by caulking, the control board 80 requires a portion to be caulked. Fixing the fixed portion 37b by welding or caulking as above may make the structure of the circuit board 80 complex and often may require more effort and cost to producing the motor for vehicle 10.

On the other hand, when fixing the fixed portion 37b to the circuit board 80 with the solder 90, the circuit board 80 requires no specific portion to be fixed, which allows the fixed portion 37b to be fixed directly to the circuit board 80. This keeps the structure of the circuit board 80 from getting complex and prevents an increase in the effort and cost required to produce the motor for vehicle 10.

Moreover, the larger the wire diameter D of the coil wire forming the first extension 37 is, the more likely the thermal stress on the fixed portion 37 is higher. Thus, the larger the wire diameter D of the coil wire is, the more useful the effect of reducing the thermal stress applied to the fixed portion 37b is. More specifically, the effect of reducing the thermal stress applied to the fixed portion 37b is useful especially when the wire diameter D is larger than or equal to 0.5 mm. The coil wire having a wire diameter D of 0.5 mm or larger is often used, especially in motors for vehicle which are mounted on a vehicle.

Moreover, according to this example embodiment, the first extension 37 extends upward from the winding end terminal of the coil wire forming the winding portion 36. Thus, when producing the first coil 35A, it is easy to adjust the length of the first extension 37 after producing the winding portion 36 by winding the coil wire. This makes it easy to adjust the length of the first extension 37 from the connected portion 37a to the fixed portion 37b so that it is longer than the virtual line segment IL1. Moreover, bent portions 37c and 37d to be described later can be produced easily, thus making it easy to install a stress relaxation structure on the first extension 37.

Furthermore, according to this example embodiment, the winding end terminal of the coil wire forming the winding portion 36 is an end portion on the lower side of the winding portion 36. As such, the length of the first extension 37, from the connected portion 37a connected to the winding end terminal of the coil wire forming the winding portion 36 to the fixed portion 37b, may be increased. This makes it easy to install the bent portions 37c and 37d to be described later on the first extension 37, so the first extension 37 may become sufficiently long.

The first extension 37 has two or more bent portions. In this example embodiment, the two bent portions, including the bent portion 37c and the bent portion 37d, are provided for each first extension 37. By providing the bent portions 37c and 37d, it becomes easier to make the first extension 37 longer than the virtual line segment IL1.

Moreover, in a case where the bent portions 37c and 37d are not provided, the force generated by axial stretching of the first extension 37 is easily applied directly to the fixed portion 37b, for example, when the first extension 37 thermally expands, and this may lead to relatively high thermal stress on the fixed portion 37b. Meanwhile, in a case where the bent portions 37c and 37d are provided, the bent portion 37c is shifted upward even if a portion of the first extension 37 from the connected portion 37a to the bent portion 37c is axially stretched, and this allows releasing the force generated by expansion of the portion extending from the connected portion 37a to the bent portion 37c. Likewise, the force generated by expansion of a portion of the first extension 37 from the bent portion 37d to the fixed portion 37b may be released as the bent portion 37d is shifted downward. Accordingly, it becomes difficult to apply the force generated by the thermal expansion of the first extension 37 directly to the fixed portion 37b, thereby reducing the thermal stress on the fixed portion 37b. The same applies to when the first extension 37 is thermally contracted.

In this way, according to this example embodiment, the thermal stress supposed to be applied to the fixed portion 37b by thermal contraction and expansion can be absorbed by the bent portions 37c and 37d. That is, the bent portions 37c and 37d provide a stress relaxation structure to the first extension 37. This can reduce the thermal stress applied to the fixed portion 37b, thereby more efficiently preventing defects such as cracks on a connection between the coil wire and the circuit board 80. Moreover, by providing two or more bent portions 37c and 37d, it becomes easier to adjust the direction in which the first extension extends, thus allowing the first extension 37 to be guided easily to a part of the circuit board 80 where the first extension 37 is fixed.

The bent portion 37c of the first extension 37 is located above the winding portion 36. The bent portion 37c is a portion formed by bending the first extension 37 so as to be inclined in a circumferential direction with respect to the axis. The bent portion 37d is located closer to the fixed portion 37b than to the bent portion 37c, in the first extension 37. The bent portion 37d is located above the bent portion 37c. The bent portion 37d is a portion formed by bending the first extension 37, which is inclined with respect to the axis by the bent portion 37c, in such a way that the direction in which the first extension 37 extends goes back to the original direction.

The bending angle θ1 of the bent portion 37c and the bending angle θ2 of the bent portion 37d are right angles or obtuse angles. Thus, the first extension 37 is bent at a lower angle to produce the bent portions 37c and 37d, which is better compared to when the bending angles θ1 and θ2 are acute angles, and this makes it easier to produce the bent portions 37c and 37d. Moreover, less coil wires may be used to produce the first extension 37. In FIG. 4, the bending angles θ1 and θ2 are, for example, obtuse angles.

Also, it is desirable that the bending angles θ1 and θ2 be right angles. This is due to the following reasons. For example, thermal expansion of the first extension 37 can be considered. In this case, a portion of the first extension 37, from the connected portion 37a to the bent portion 37c, expands axially, thus applying an upward force on the bent portion 37c. Also, a portion of the first extension 37, from the bent portion 37d to the fixed portion 37b, expands axially, thus applying a downward force on the bent portion 37d. Accordingly, the upward force and the downward force are respectively applied to two ends of the portion between the bent portions 37c and 37d of the first extension 37, thus generating a rotation moment perpendicular to the axis which causes the portion between the bent portions 37c and 37d to rotate around the axis. Hereinafter, the portion of between the bent portions 37c and 37d of the first extension 37 is referred to as a “middle portion”.

Here, the force that generates the rotation moment applied to the middle portion is a component of the force applied to two ends of the middle portion, that is perpendicular to the direction in which the middle portion extends. If the bending angles θ1 and θ2 are right angles, the direction in which the middle portion extends is perpendicular to the axis. As such, the entire or most of the axial force applied to two ends of the middle portion when the first extension 37 thermally expands is used as a force that generates a rotation moment for rotating the middle portion. Therefore, with the bending angles θ1 and θ2 being right angles, the force generated by thermal expansion of the first extension 37 is kept from being applied to the fixed portion 37b, thereby further reducing the thermal stress on the fixed portion 37b. Moreover, the thermal stress applied to the fixed portion 37b by thermal contraction of the first extension 37 may be reduced too, as is the case with the thermal expansion of the first extension 37.

The bending angle θ1 is an angle formed between the portion between the connected portion 37a and bent portion 37c of the first extension 37 and the portion between the bent portion 37c and bent portion 37d of the first extension 37. The bending angle θ2 is an angle formed between the portion between the bent portion 37c and bent portion 37d of the first extension 37 and the portion between the bent portion 37d and fixed portion 37b of the first extension 37.

In this example embodiment, the bending angle θ1 and the bending angle θ2 are, for example, equal. As such, the direction in which the portion between the connected portion 37a and bent portion 37c of the first extension 37 extends and the direction in which the portion between the bent portion 37d and fixed portion 37b of the first extension 37 may be made parallel to each other.

The portion between the connected portion 37a and bent portion 37c of the first extension 37 extends parallel to the axis. The portion between the bent portion 37c and bent portion 37d of the first extension 37 extends in such a way as to be inclined in circumferential direction with respect to the axis. The portion between the bent portion 37d and fixed portion 37b of the first extension 37 extends parallel to the axis.

As shown in FIG. 3, the third coils 35Aa each have a third extension 37Aa as the above-described first extension 37. The fixed portion 37b of the third extension 37Aa is placed above the winding portion 36 where the third extension 37Aa is connected. The bent portion 37c of the third extension 37Aa is a portion formed by bending the third extension 37Aa so as to be inclined toward the winding portion 36 on the circumference with respect to the axis. The portion between the bent portion 37c and bent portion 37d of the third extension 37Aa is located alongside the winding portion 36 on the circumference as it is directed upward.

The fourth coils 35Ab each have a fourth extension 37Ab as the above-described first extension 37. The fixed portion 37b of the fourth extension 37Ab is placed above a winding portion 36 different from the winding portion 36 where the fourth extension 37Ab is connected. In this example embodiment, the fixed portion 37b of the fourth extension 37Ab is placed above a winding portion 36 where the third extension 37Aa is connected. The bent portion 37c of the fourth extension 37Ab is a portion formed by bending the fourth extension 37Ab so as to be inclined in the opposite direction of the winding portion 36 on the circumference with respect to the axis.

The fourth extension 37Ab has an extended winding portion 37e between two bent portions 37c and 37d. The turnaround portion 37e extends above a winding portion 36 different from the winding portion 36 where the fourth extension 37Ab is connected. In this example embodiment, the turnaround portion 37e extends away from the winding portion 36 where the fourth extension 37Ab is connected, in a circumferential direction, all the way to above the winding portion 36 where the third extension 37Aa is connected.

An insulation tube 39 is mounted to the turnaround portion 37e. The insulation tube 39 is a tube with insulation properties that covers at least part of the turnaround portion 37e. By covering the turnaround portion 37e by the insulation tube 39, the turnaround portion 37e is kept from being short-circuited to other coils 35. In this example embodiment, the insulation tube 39 is in the shape of a cylinder into which the turnaround portion 37e passes, and covers almost the entire turnaround portion 37e.

The bending angles θ1 and θ2 of the bent portions 37c and 37d of the fourth extension 37Ab are smaller than the bending angles θ1 and θ2 of the bent portions 37c and 37d of the third extension 37Aa. In this example embodiment, the bending angles θ1 and θ2 of the bent portions 37c and 37d of the fourth extension 37Ab are approximately 90°. As such, the turnaround portion 37e extends in a direction nearly perpendicular to the axis. The turnaround portion 37e linearly extends the upper sides of the plurality of coils 35 that are circumferentially arranged.

In this example embodiment, three third coils 35Aa are placed adjacent to each other, for example, in a circumferential direction. In this example embodiment, three fourth coils 35Ab are placed adjacent to each other, for example, in a circumferential direction. The group of three third coils 35Aa and the group of three fourth coils 35Ab are placed adjacent to each other in a circumferential direction.

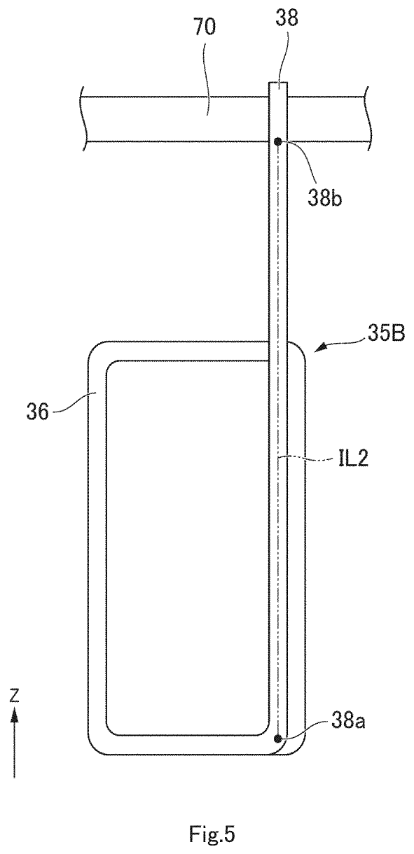

As shown in FIG. 5, the second coil 35B has a second extension 38. That is, at least one of the plurality of coils 35 is a second coil 35B having a second extension 38. The second extension 38 is formed by extending the coil wire upward from the winding portion 36. The second extension 38 extends upward from the winding portion 36, and is connected to the neutral bus bar 70. The coil wire forming the winding portion 36 and the coil wire forming the second extension 38 are part of a single continuous coil wire. The second extension 38 has a connected portion 38a and a fixed portion 38b.

The connected portion 38a is an end portion on the lower side of the second extension 38, and is a portion connected to the winding portion 36. In this example embodiment, the connected portion 38a is connected to a winding start terminal of the coil wire forming the winding 36. That is, in this example embodiment, the second extension 38 extends upward from the winding start terminal of the coil wire forming the winding portion 36. In this example embodiment, the winding start terminal of the coil wire forming the winding portion 36 is an end portion on the lower side of the winding portion 36.

The fixed portion 38b is a portion fixed to the neutral bus bar 70. The fixed portion 38b is placed above the winding portion 36. In this example embodiment, the fixed portion 38b is fixed by welding to the radial outer side of the plate surface of the neutral bus bar 70. The second extension 38 extends linearly from the winding portion 36 to the neutral bus bar 70, and is fixed to the neutral bus bar 70. As such, the length of the second extension 38 from the connected portion 38a to the fixed portion 38b is preferably equal to the length of the virtual line segment IL2 joining the connected portion 38a and the fixed portion 38b.

Moreover, the point at the fixed portion 38b connected by the virtual line segment IL2 is the point on the fixed portion 38b closest to the connected portion 38a—that is, the point on the lower side in this example embodiment. In this example embodiment, the point on the fixed portion 38b connected by the virtual line segment IL2 is at approximately the same axial location as the lower edge of the neutral bus bar 70.

Since the second extension 38 is fixed to the neutral bus bar 70, the second extension 38 may be connected directly to the neutral bus bar 70 by welding. Accordingly, unlike the above-described circuit board 80, the structure of the neutral bus bar 70 is kept from getting complex, even with the use of welding. This can prevent an increase in the effort and cost required to produce the motor for vehicle 10, and the second extension 38 and the neutral bus bar 70 can be firmly fixed together by welding. As such, even if a thermal stress is created on the fixed portion 38b, it is possible to prevent defects on a connection between the second extension 38 and the neutral bus bar 70. Therefore, the second extension 38 may be configured in such a way that it extends linearly and is fixed to the neutral bus bar 70, which allows the use of less coil wires to produce the second extension 38.

Moreover, unlike the first extension 37, the second extension 38 does not need to be specifically adjusted in length as long as it can be connected to the neutral bus bar 70. Thus, the second extension 38 may be easily configured in such a way as to extend upward from the winding start terminal of the coil wire forming the winding 36. The winding start part of the coil wire is hard to move compared to the winding end part of the coil wire because it is pressed by the winding portion 36. As such, the second extension 38 can be easily kept in a stable position, thus making it easier to fix the second extension 38 to the neutral bus bar 70.

As shown in FIG. 2, in this example embodiment, six second coils 35B are placed adjacent to each other, for example, in a circumferential direction. The second extensions 38 of three of the six second coils 35B, which are adjacent in a circumferential direction, are fixed to the neutral bus bar 70 on one side. The second extensions 38 of another three of the six second coils 35B, which are adjacent in a circumferential direction, are fixed to the neutral bus bar 70 on the other side. As such, each neutral bus bar 70 connects three second coils 35B as neutral points.

In this example embodiment, one first coil 35A and one second coil 35B are formed by a single continuous coil wire. That is, a single continuous coil wire forms two winding portions 36, one first extension 37, and one second extension 38. The winding start terminal of the single continuous coil wire is the second extension 38, and the winding end terminal thereof is the first extension 37. In this example embodiment, six first coils 35A and six second coils 35B are formed by six continuous coil wires. More specifically, three third coils 35Aa and three second coils 35B are formed by three of the six continuous coil wires. Three fourth coils 35Ab and three second coils 35B are formed by another three of the six continuous coil wires.

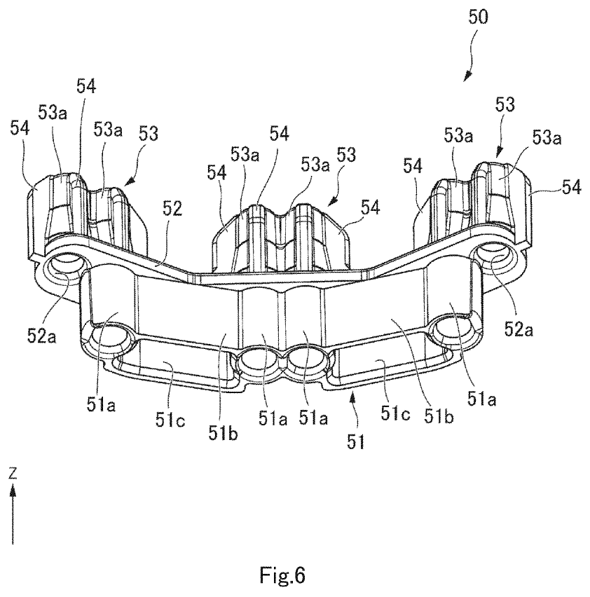

The first support member 50 is a member with insulating properties. As shown in FIG. 3, the first support member 50 supports the first extensions 37. The first support member 50 has a base portion 51, a plate-like portion 52, and guide portions 53. The base portion 51 extends along the circumference. As shown in FIG. 6, the base portion 51 has a plurality of lower guide cylinder portions 51a and connecting portions 51b. The lower guide cylinder portions 51a are in the shape of a cylinder that extend axially. The lower guide cylinder portions 51a opens to both sides of the axis. A total of four lower guide cylinder portions 51a are provided, one on either end of the base portion 51 on the circumference and two at the center of the base portion 51 on the circumference. The two lower guide cylinder portions 51a placed at the center of the base portion 51 on the circumference are placed adjacent to each other in a circumferential direction.

The connecting portions 51b are in the shape of a square cylinder that opens downward. The connecting portions 51b extend linearly along the circumference. Two connecting portions 51b are installed. One of the connecting portions 51b connects the lower guide cylinder portion 51a placed at one end of the base portion on the circumference and one of the lower guide cylinder portions 51a placed at the center of the base portion 51 on the circumference. The other connecting portion 51b connects the lower guide cylinder portion 51a placed at the other end of the base portion 51 on the circumference and the other lower guide cylinder portion 51a placed at the center of the base portion 51 on the circumference.

The plate-like portion 52 is in the shape of a plate that extends in a angulated bending line along the circumference. The plate surface of the plate-like portion 52 is perpendicular to the axis. The plate-like portion 52 is connected to the top side of the base portion 51. Both ends of the plate-like portion 52 on the circumference protrude out from both sides of the base portion 51 on the circumference. The plate-like portion 52 has through-holes 52a that penetrate the plate-like portion 52 in an axial direction. A total of six through-holes 52a are provided, one on either side of the plate-like portion 52 that protrudes out from both sides of the base portion 51 on the circumference, and, although not shown, one on each part of the plate-like portion 52 that axially overlaps the lower guide cylinder portions 51a.

The guide portions 53 protrude upward from the top surface of the plate-like portion 52. The guide portions 53 each have two upper guide cylinder portions 53a and a plurality of ribs 54. The two upper guide cylinder portions 53a are in the shape of a cylinder that opens to both sides of the axis. The two upper guide cylinder portions 53a are placed adjacent to each other in a circumferential direction. As shown in FIG. 1, the inner diameter of the upper guide cylinder portions 53a is smaller at the top of the upper guide cylinder portions 53a.

As shown in FIGS. 3 and 6, a total of three guide portions 53 are provided, one on either end of the plate-like portion 52 on the circumference and one at the center of the plate-like portion 52 on the circumference. In the three guide portions 53, two of the six upper guide cylinder portions 53a located on opposite ends on the circumference are placed where the plate-like portion 52 protrudes out from both sides of the base portion 51 on the circumference. The insides of the two upper guide cylinder portions 53a are exposed out of the first support member 50 through the through-holes 52a of the plate-like portion 52. Four of the six upper guide cylinder portions 53a, but not the upper guide cylinder portions 53a located on opposite ends on the circumference, are positioned to axially overlap the lower guide cylinder portions 51a. The insides of the four upper guide cylinder portions 53a are connected to the insides of the lower guide cylinder portions 51a through the through-holes 52a of the plate-like portion 52.

As shown in FIG. 1, the upper guide cylinder portion 53a is inserted into the holder through-hole 41 of the bearing holder 40. The first extension 37 is passed through the inside of the upper guide cylinder portion 53a. More specifically, as shown in FIG. 3, the fixed portion 37b of the first extension 37—that is, the portion above the bent portion 37d—is passed through the inside of the upper guide cylinder portion 53a. As such, the first support member 50 supports the portion above the bent portion 37d of the first extension 37. Accordingly, the fixed portion 37b can be easily kept in a stable position, thus making it easier to fix the fixed portion 37b to the control board 80. Also, it is easy to pass the first extension 37 through the upper guide cylinder portion 53a, as compared to when the portion below the bent portion 37d is supported.

The first extensions 37 that are passed through the insides of two of the six upper guide cylinder portions 53a located on opposite ends on the circumference are inserted into the upper guide cylinder portions 53a from the through-holes 52a of the plate-like portion 52. The first extensions 37 that are passed through the insides of the other four upper guide cylinder portions 53a are inserted into the lower guide cylinder portions 51a from below and inserted into the upper guide cylinder portions 53a through the through-holes 52a of the plate-like portion 52.

In each guide portion 53, a third extension 37Aa, which is the first extension 37 of a third coil 35Aa, and a fourth extension 37Ab, which is the first extension 37 of a fourth coil 35Ab, are passed through two upper guide cylinder portions 53a.

The plurality of ribs 54 are in the shape of a plate that protrudes outward from the outer circumference of each upper guide cylinder portion 53a and extends axially. For example, at least three ribs 54 are provided on each upper guide cylinder portion 53a. With the ribs 54, the rigidity of the upper guide cylinder portions 53a can be improved.

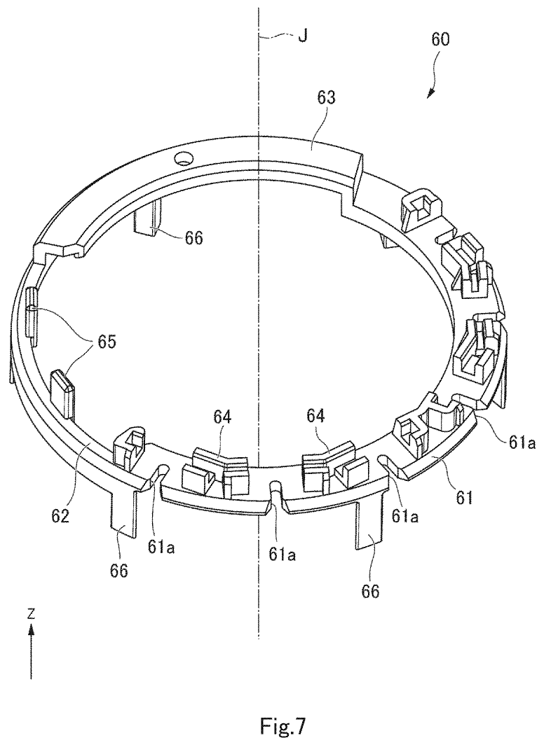

The second support member 60 is a member with insulating properties. As shown in FIG. 7, the second support member 60 is in the shape of a circular ring around the central axis J. The second support member 60 has a bus bar support 61, holding projections 64, a first support member connecting portion 62, connecting projections 65, a protrusion 63, and support legs 66.

The bus bar support 61 is in the shape of a plate that extends in an arc along the circumference. The plate surface of the bus bar support 61 is perpendicular to the axis. As shown in FIG. 2, the bus bar support 61 is placed above the six second coils 35B. The neutral bus bars 70 are held above the bus bar support 61.

The bus bar support 61 has support recesses 61a which are recessed radially inward from the radial outer edge of the bus bar support 61. Six support recesses 61a are provided along the circumference. The second extensions 38 are passed through the insides of the support recesses 61a, respectively. As such, the second extensions 38 may be supported on the inner surfaces of the support recesses 61a, so that the second extensions 38 are kept in a stable position. Accordingly, it is easy to fix the second extensions 38 to the neutral bus bars 70.

The holding projections 64 protrude upward from the top surface of the bus bar support 61. A plurality of holding projections 64 are provided along the circumference. The holding projections 64 each have a downwardly recessed groove. The neutral bus bars 70 are fitted to the grooves of the holding projections 64. Thus, the neutral bus bars 70 are held through the plurality of holding projections 64, on the top side of the bus bar support 61.

As shown in FIG. 7, the first support member connecting portion 62 extends in an arc along the circumference, from the ends of the bus bar support 61 on the circumference. Radial dimensions of the first support member connecting portion 62 are smaller than radial dimensions of the bus bar support 61. As shown in FIG. 2, the first support member 50 is connected to the top side of the first support member connecting portion 62. The first support member connecting portion 62 supports the first support member 50 from the underside.

As shown in FIG. 7, the connecting projections 65 are in the shape of a plate that protrudes upward from the first support member 62. The plate surfaces of the connecting projections 65 are perpendicular to the radius. The connecting projections 65 are inserted into the connecting portions 51b. As such, the first support member 50 is kept from moving radially with respect to the second support member 60. Accordingly, the first support member 50 and the second support member 60 may be properly connected.

The protrusion 63 is in the shape of a plate that extends in an arc along the circumference. The plate surface of the protrusion 63 is perpendicular to the axis. The protrusion 63 connects an end of the bus bar support 61 on the circumference and an end of the first support member connecting portion 62 on the circumference. The protrusion 63 is configured to protrude upward from the bus bar support 61 and the first support member connecting portion 62. As shown in FIG. 2, the protrusion 63 is placed above the three fourth coils 35Ab. This allows a space below the protrusion 63 for the turnaround portions 37e to extend.

The protrusion 63 is placed above the bent portions 37c and 37d. That is, the bent portions 37c and 37d are placed below the second support member 60. As such, it is easy to bend and turn the first extensions 37 around by means of the bent portions 37c and 37d below the second support member 60 and aggregate the fixed portions 37b of the first extensions 37 within a certain area on the circumference.

In this example embodiment, the fixed portion 37b of the first extensions 37 are aggregated at a circumferential location on the first support member connecting portion 62 and supported on the first support member 50. Thus, circumferential dimensions of the first support member 50 may become smaller, and therefore circumferential dimensions of the first support member connecting portion 62 may become smaller, too. As such, circumferential dimensions of the bus bar support 61 may become relatively larger. Therefore, the freedom of placement of the neutral bus bars 70 supported on the bus bar support 61 can be improved. Moreover, even if a plurality of neutral bus bars 70 are provided as in this example embodiment, the neutral bus bars 70 may be easily placed by circumferentially arranging them.

As shown in FIG. 7, the support legs 66 protrude downward from the bus bar support 61, first support member connecting portion 62, and protrusion 63. One or a plurality of support legs 66 are provided for each of these components. As shown in FIG. 2, the support legs 66 make contact with the top surface of the core back 32. As such, the second support member 60 is supported from the underside by the stator core 31.

The present disclosure is not limited to the above-described example embodiment, but may employ other configurations below. Each first extension may have one bent portion or three or more. The bending angles of the bent portions may be acute angles. The bending angles of the bent portions may be different from each other. The first extension may have no bent portion. In this case, the first extension may extend, for example, in a curve. The fixed portion of the first extension may be fixed to the control board by other methods than soldering, for example, welding, caulking, etc. The first extension may extend from the winding start terminal of the coil wire forming the winding portion.

In the above example embodiment, the first coils 35A comprise, but are not limited to, third coils 35Aa and fourth coils 35Ab. All the first coils 35A may be third coils 35Aa or fourth coils 35Ab. Each coil may be connected in a delta connection. The wire diameter D of the coil wires forming the coils is not specifically limited. The coil wires may not be round wires, or may be rectangular wires. The coils having a fourth extension with a turnaround portion may not be provided. The insulation tube may not be provided. The first support member and the second support member may not be provided. Only a single neutral bus bar may be provided. No neutral bus bar may be provided.

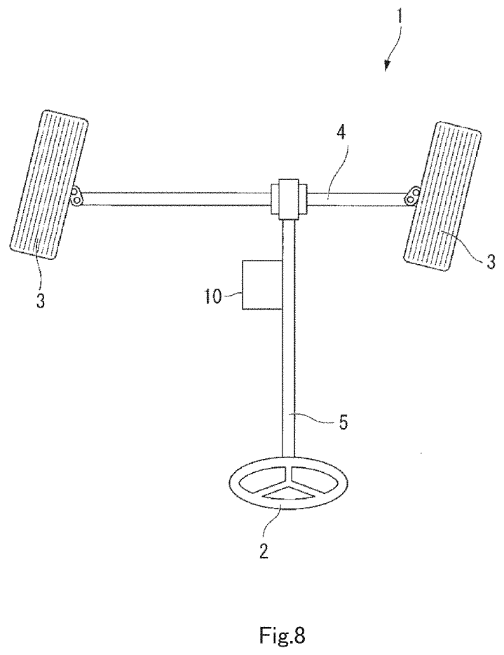

The electric power steering device 1 shown in FIG. 8 is mounted on a steering mechanism for wheels of a vehicle. The electric power steering device 1 in this example embodiment is a column-assist power steering device which, powered by the motor 10, reduces steering forces on its own. The electric power steering device 1 comprises the motor for vehicle 10, a steering shaft 5, and an axle 4. The steering shaft 5 transfers input from steering 2 to the axle 4 having wheels 3. The power of the motor for vehicle 10 is transferred to the axle 4 through a ball screw (not shown).

The electric power steering device 1 of this example embodiment is equipped with a motor for vehicle 10 capable of reducing defects on a connection between coil wires and a circuit board 80. Thus, the electric power steering device 1 can achieve high reliability. While the electric power steering device 1 as described herein is cited as an example of the use of the motor for vehicle 10 of this example embodiment, the use of the motor for vehicle 10 is not specifically limited as long as it is mounted on a vehicle.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-13. (canceled)

14: A motor of a vehicle which is mounted on a vehicle, the motor comprising:
a motor including a shaft placed along the central axis;
a rotor radially opposed to the rotor through a gap; and
a circuit board placed on one side of the central axis of the stator and electrically connected to the stator, wherein
the stator includes:
a stator core; and
a plurality of coils each having a winding portion which is defined by winding a coil wire onto the stator core,
at least one of the plurality of coils is a first coil including a first extension which is defined by a portion of the coil wire extending to one side of the central axis from the winding portion,
the first extension includes:
a connected portion connected to the winding portion; and
a fixed portion fixed to the circuit board,
a total length of the first extension, from the connected portion to the fixed portion, is larger than the length of a virtual line segment joining the connected portion and the fixed portion.

15: The motor of a vehicle of claim 14, wherein the first extension includes two or more bent portions.

16: The motor of a vehicle of claim 15, wherein the bending angles of the bent portions are right angles or obtuse angles.

17: The motor of a vehicle of claim 15, further comprising
a first support that has insulating properties and supports the first extension, wherein
the first support supports one side of an axis of the first extension, rather than the bent portions.

18: The motor of a vehicle of claim 15, further comprising:
a neutral bus bar that connects two or more of the plurality of coils as neutral points; and
a second support member that has insulating properties and supports the neutral bus bar, wherein
at least one of the plurality of coils is a second coil including a second extension which is defined by a portion of the coil wire extending to one side of the central axis from the winding portion, the second extension is fixed to the neutral bus bar, and the bent portions are placed on another side of the central axis, rather than on the second support member.

19: The motor of a vehicle of claim 14, further comprising
a neutral bus bar that connects two or more of the plurality of coils as neutral points, wherein
at least one of the plurality of coils is a second coil including a second extension which is defined by a portion of the coil wire extending to one side of the central axis from the winding portion, and the second extension extends linearly from the winding portion to the neutral bus bar and is fixed to the neutral bus bar.

20: The motor of a vehicle of claim 18, wherein the second extension extends to one side of the axis from a winding start terminal of the coil wire defining the winding portion.

21: The motor of a vehicle of claim 14, wherein the first extension extends to one side of the axis from a winding end terminal of the coil wire forming the winding portion.

22: The motor of a vehicle of claim 21, wherein the winding end terminal of the coil wire defining the winding portion is an end portion on the other side of the axis of the winding portion.

23: The motor of a vehicle of claim 14, wherein the fixed portion is fixed to the circuit board by soldering.

24: The motor of a vehicle of claim 14, wherein the wire diameter of the coil wires is about 0.5 mm or more.

25: The motor of a vehicle of claim 14, wherein
a plurality of first coils are provided,
the plurality of first coils include:
third coils each including a third extension as the first extension; and
fourth coils each including a fourth extension as the first extension,
the fixed portion of the third extension is placed on one side of the central axis of the winding portion where the third extension is connected, and the fixed portion of the fourth extension is placed on one side of the central axis of a winding portion different from the winding portion where the fourth extension is connected,
the fourth extension comprising:
two bent portions; and
a turnaround portion between the two bent portions,
the turnaround portion extends to one side of an axis of a winding portion different from the winding portion where the fourth extension is connected, and the stator includes an insulation tube with insulation properties that covers at least a portion of the turnaround portion.

26: An electric power steering device equipped with the motor of a vehicle of claim 14.
